(19) United States
(12) Patent Application Publication
(10) Pub. No.: US 2006/0011029 A1
(43) Pub. Date: Jan. 19, 2006

(54) Apparatus and process for severing meat trays

(76) Inventor: Jere F. Irwin, Yakima, WA (US)

Correspondence Address: WELLS ST. JOHN P.S., 601 W. FIRST AVENUE, SUITE 1300, SPOKANE, WA, 99201, US

(21) Appl. No.: 11/232,794

(22) Filed: Sep. 21, 2005

Related U.S. Application Data
(62) Division of application No. 09/866,088, filed on May 25, 2001, now abandoned.

(51) Int. Cl. B26D 7/00

(52) U.S. Cl. 83/13; 83/268; 83/418; 83/945

(57) ABSTRACT

A thermoformed article trim apparatus is provided for severing thermoformed articles with an accurately trimmed lip edge from a thermoformed web in which each article has diagonally opposing corner surfaces, comprising an article die; an article punch opposing the article die; an alignment fixture carried by the punch and having complementary exterior alignment corner surfaces configured to engage inclined interior corner surfaces of the article to maintain the article in alignment in longitudinal, lateral and angular directions; and a drive mechanism connected to at least one of the die and the punch and configured to move at least one of the punch and the die relative to each other a first distance to move the alignment fixture into the article with the exterior alignment corner surfaces of the article to accurately align the article in the longitudinal, lateral and angular directions and further configured to move a second distance to accurately trim the article from the web to generate an accurately formed lip around a periphery of the article while the alignment fixture corner surfaces are engaging the article corner surfaces. A process is also provided.

### RELATED PATENT DATA

This application claims the benefits of U.S. patent application Ser. No. 09/866,088, entitled “A Thermal Plastic Expanded Foam Meat Tray and Method and Apparatus for Precisely Trimming the Meat Tray From an Expanded Foam Web”, which was filed May 25, 2001, and which is incorporated by reference herein.

### TECHNICAL FIELD

This invention pertains to thermal plastic expanded foam meat trays and methods and apparatus for trimming the meat trays from an expanded foam web.

### BACKGROUND OF THE INVENTION

Often it is necessary, after food is placed in the meat tray, to cover the top opening with a plastic or metal film having an airtight seal all around the top opening flange to help preserve the food, minimize oxidation and prevent food contamination while the food is being transported and presented for sale. Thus it is very important that top flanges of the thermal plastic expanded foam meat trays be accurately trimmed to provide a uniform seal surface on the flange to receive the plastic or metal film.

### SUMMARY OF THE INVENTION

An apparatus and method are provided for forming a thermal plastic expanded foam rectangular meat tray that is trimmed from a thermal plastic expanded foam web. The thermal plastic expanded foam is a thermoformable plastic material such as a polystyrene foam. The meat tray includes alignment features that accurately align the meat tray when severing the formed meat tray from a web of thermal plastic expanded foam material.

According to one aspect, a thermal plastic expanded foam rectangular meat tray is configured to be trimmed from a thermal plastic expanded foam web. The meat tray includes a substantially rectangular bottom wall, and side walls. The side walls extend upward and outward from the bottom wall integrally interconnected to each other at four corners. Each of the side walls has an inclined lower section and an upper section that extends upwardly and terminating in a lip that extends outward around the periphery of the tray. The upper wall section has internal inclined corner surfaces extending upward and outward to the lip at the four corners. Each of the corner surfaces is specifically provided to receive an internal complementary mating corner alignment fixture in order to maintain the tray accurately aligned at the corners as the tray is being trimmed from the thermal plastic expanded foam web.

According to another aspect, a process is provided for severing uncut thermoformed rectangular meat trays with precisely trimmed lips from a thermal plastic expanded foam web in which each meat tray has diagonally opposing steeply inclined interior corner surfaces. The process includes: (a) moving the web to place at least one of the rectangular meat trays between a rectangular meat tray punch and a rectangular meat tray die, in which the rectangular punch has an alignment fixture thereon with complementary steeply inclined exterior alignment surfaces for engaging the steeply inclined interior corner surfaces of the meat trays; (b) moving the punch and die relative to each other a first distance to insert the alignment fixture within the meat tray with the alignment surfaces engaging the diametrically opposed interior corner surfaces of the meat tray to accurately align the meat tray longitudinally, laterally and angularly with respect to the punch and die; and (c) while maintaining the alignment surfaces in engagement with the corner surfaces, moving the punch and die relative to each other a second distance to sever the meat tray from the web with a precisely formed lip about its periphery.

According to yet another aspect, the trim apparatus is provided for severing uncut thermal formed rectangular meat trays to produce precisely trimmed lips when removing the trays from a thermal plastic expanded foam web. Each meat tray has diagonally opposing steeply inclined interior corner surfaces. The trim apparatus includes a rectangular meat tray die, a rectangular meat tray punch, an alignment fixture, a placement means for placing an untrimmed meat tray between the punch and the die, and drive means operatively connected to the die and punch. The rectangular meat tray punch opposes the rectangular meat tray die. The alignment fixture is mounted on the punch having complementary exterior alignment corner surfaces thereon for engaging the steeply inclined interior corner surfaces of the meat tray to maintain the meat tray in alignment in longitudinal, lateral and angular directions. The drive means are operatively connected to the die and punch for moving the punch and die relative to each other a first distance in order to move the alignment fixture into the meat tray with the exterior alignment corner surfaces engaging the steeply inclined interior corner surfaces of the meat tray to accurately align the meat tray in the longitudinal, lateral, and angular directions. The drive means are further operatively connected to the die and punch for moving a second distance to accurately trim the meat tray from the web with a precisely formed lip about its periphery while the fixture corner surfaces are engaging the tray corner surfaces.

### BRIEF DESCRIPTION OF THE DRAWINGS

Preferred embodiments of the invention are described below with reference to the following accompanying drawings.

FIG. 1 is a schematic view of a thermal expanded foam web passing by a preheat station, a meat tray forming station, and a trim press station for forming unique rectangular-shaped meat trays and separating the formed meat trays from the web;

FIG. 2 is an isometric view of a preferred embodiment of the unique meat tray;

FIG. 3 is a top view of the meat tray shown in FIG. 2;

FIG. 4 is a side view of the meat tray shown in FIG. 3;

FIG. 5 is a fragmentary vertical cross-sectional view taken along line 5-5 in FIG. 3;

FIG. 6 is a fragmentary vertical cross-sectional view taken along line 6-6 in FIG. 3;

FIG. 7 is an enlarged fragmentary top view taken along circle line 7 in FIG. 3 showing a corner of the meat tray;

FIG. 8 is an fragmentary isometric view of a punch platen used at the trim station, along with other components, for separating formed trays from the web;

FIG. 9 is a fragmentary isometric view of a female die platen used in conjunction with the punch platen shown in FIG. 8 for separating formed meat trays from the web;

FIG. 10 is a fragmentary vertical cross-sectional view through opposing punch platen and female die platen showing vertical movement of the punch platen to trim one of the meat trays from the web;

FIG. 11 is a horizontal cross-sectional view taken along line 11-11 in FIG. 10 emphasizing an alignment fixture mounted on the punch platen for aligning the meat tray as the tray is being trimmed and separated from the web; and

FIG. 12 is a vertical cross-sectional view taken along line 12-12 in FIG. 11 illustrating the insertion of the alignment fixture into an upper portion of meat tray to align the meat tray prior to the tray being trimmed from the web.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

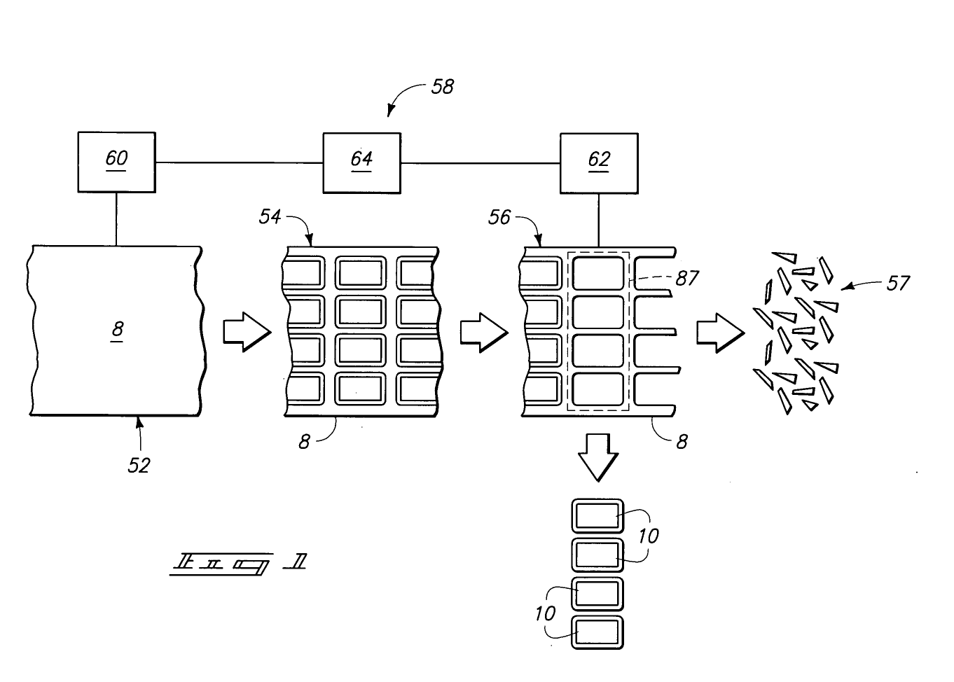

FIG. 1 illustrates a thermal plastic expanded foam web or sheet 8 passing through a pre-heat station 52 and a meat tray forming station 54 for forming meat trays 10. The web 8 with the formed trays then moves to a meat tray trim station 56 for separating the formed meat trays 10 from the web 8 and then past a web comminuting station 57 for shredding the remaining web after the meat trays 10 have been removed from the web 8. The web 8 is incrementally fed to the meat tray trims station 56 by a conveying means generally designated by the numeral 58 in FIG. 1. Such a conveying means 58 includes drive motors 60 and 62 that drive web rollers (not shown) for moving the web 8. The motors 60 and 62 are controlled by a servo motor controller 64. Such a conveying means is shown in more detail in U.S. Pat. No. 6,067,886 granted to the present Applicant on May 30, 2000 and entitled “A Machine Trim Press Having Counterbalance Features”. Such patent is incorporated herein by reference.

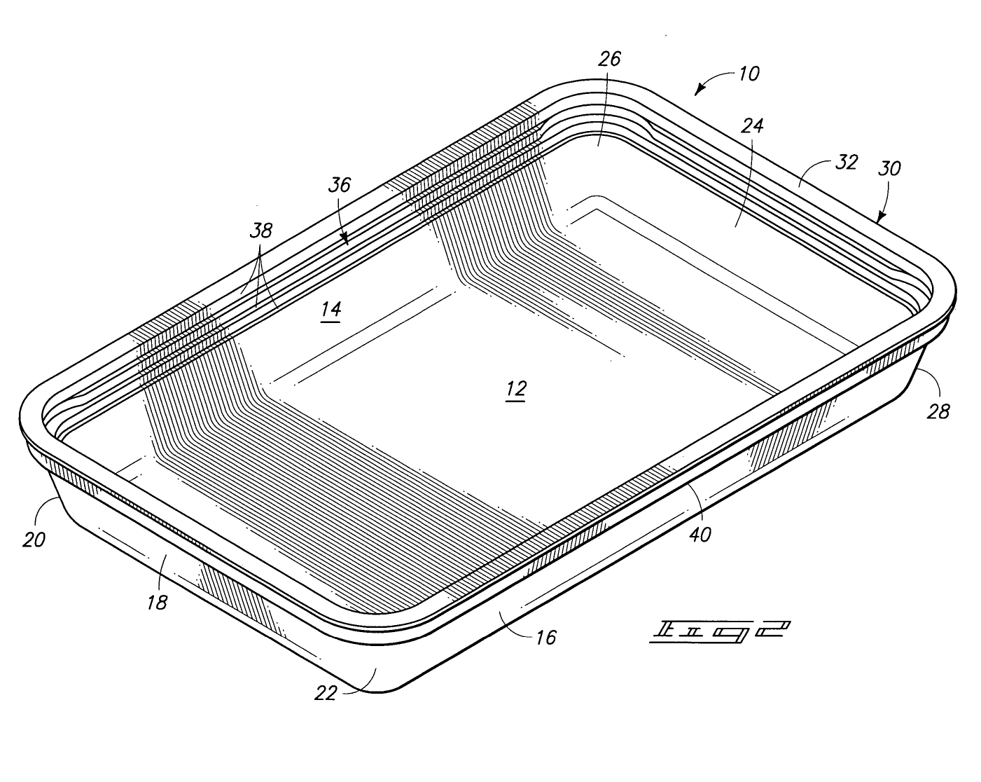

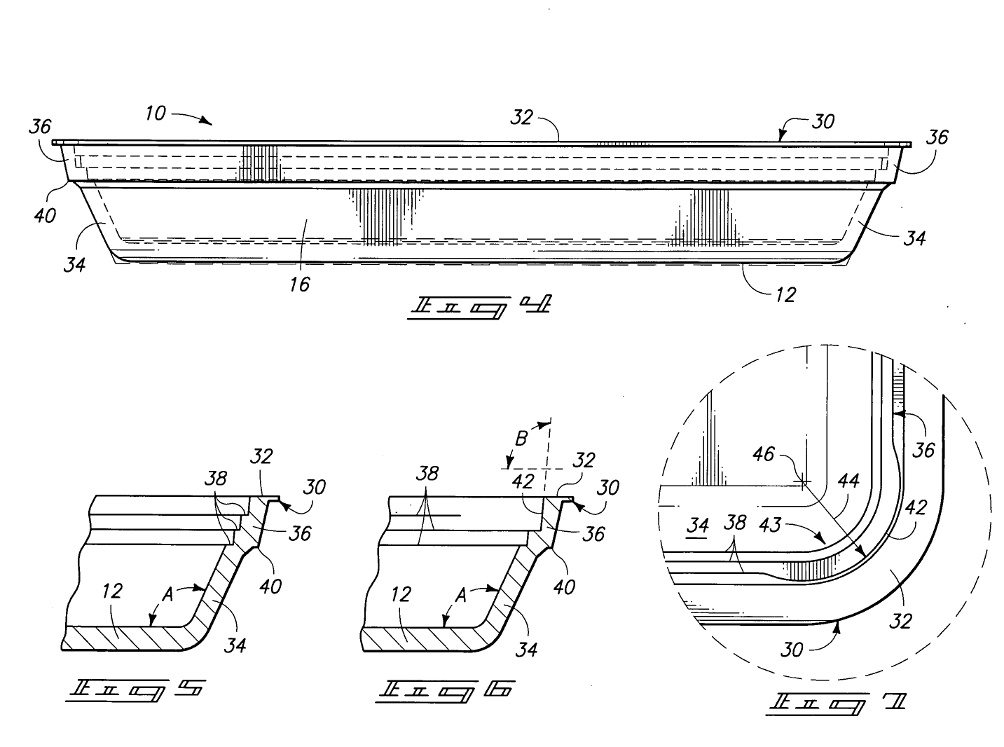

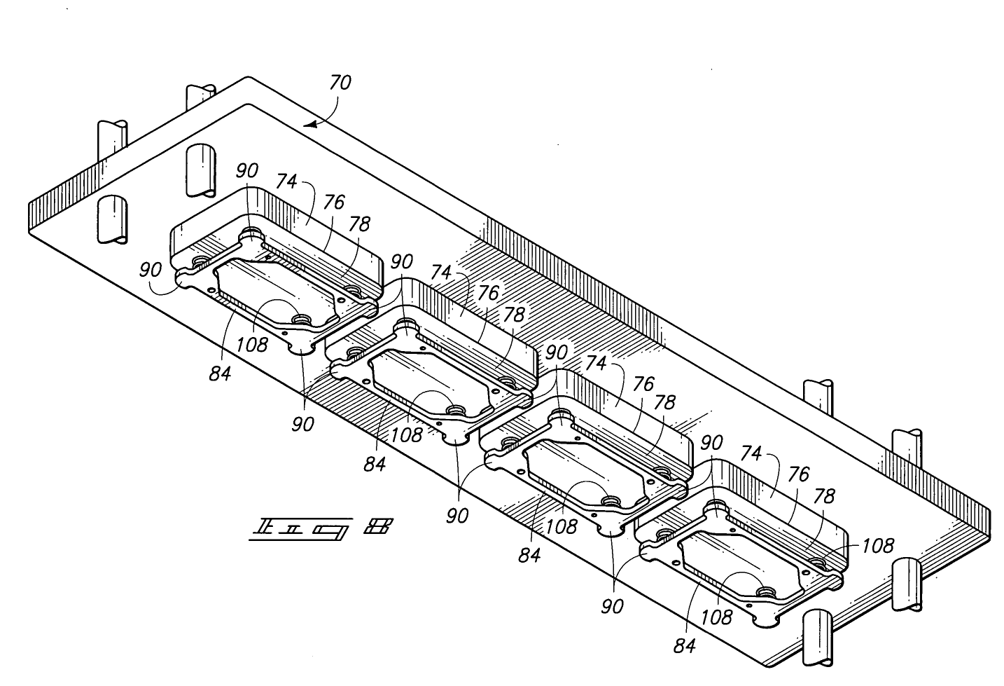

FIGS. 2-7 illustrate a preferred embodiment of the unique rectangular-shaped meat tray 10. The expanded foam meat tray 10 has a rectangular bottom wall 12 with long side walls 14 and 16 that are interconnected by short end or side walls 18 and 24. The short side wall 18 is formed integrally with the long side walls 14 and 16 at curved wall corners 20 and 22. The short side wall 24 is formed integrally with the long side walls 14 and 16 at curved wall corners 26 and 28. The side walls 14, 16, 18 and 24 extend upward and outward from the bottom wall 12 to a peripheral outwardly extending flange or lip 30. The lip 30 has an upper surface 32 that forms a seal surface for enabling films to be laid over the tray and affixed to the surface 32 to provide airtight seal protection to the food product placed in the tray 10. The side walls 14, 16, 18 and 24 extend upward and outward at an obtuse angle “A” of between 110 degrees and 140 degrees relative to the bottom wall 12 (FIGS. 5 and 6). The side walls 14, 16, 18 and 24 have lower wall sections 34 that extend upward and outward to upper wall sections 36. The upper wall section 36 extends upward and outward from an external nesting shoulder 40 to the peripheral lip 30. The upper wall sections 36 have a series of internal stepped ribs 38 formed therein to provide strength and rigidity to minimize bulging of the side walls.

Importantly, each of the wall corners 20, 22, 26, and 28 has an internal inclined alignment corner surface 42 formed therein extending downwardly from the inside of the lip 30 toward the bottom wall 12 for receiving a complementary surface of an alignment fixture to maintain the meat tray 10 in alignment, in the longitudinal, lateral, diagonal and angular directions, while the tray 10 is being precisely trimmed from the web 8 at the trimming station 56. Preferably the alignment corner surfaces 42 extend downward at a steep obtuse angle “B” of between 94 degrees and 105 degrees relative to the bottom wall 12 (FIGS. 4 and 5). Preferably angle “B” is between 94 degrees and 100 degrees. Preferably the alignment corner surfaces 42 extend downward from the lip 30, on the inside of the upper wall sections 36, eliminating part or all of one or more ribs 38 in the corners 20, 22, 26, and 28.

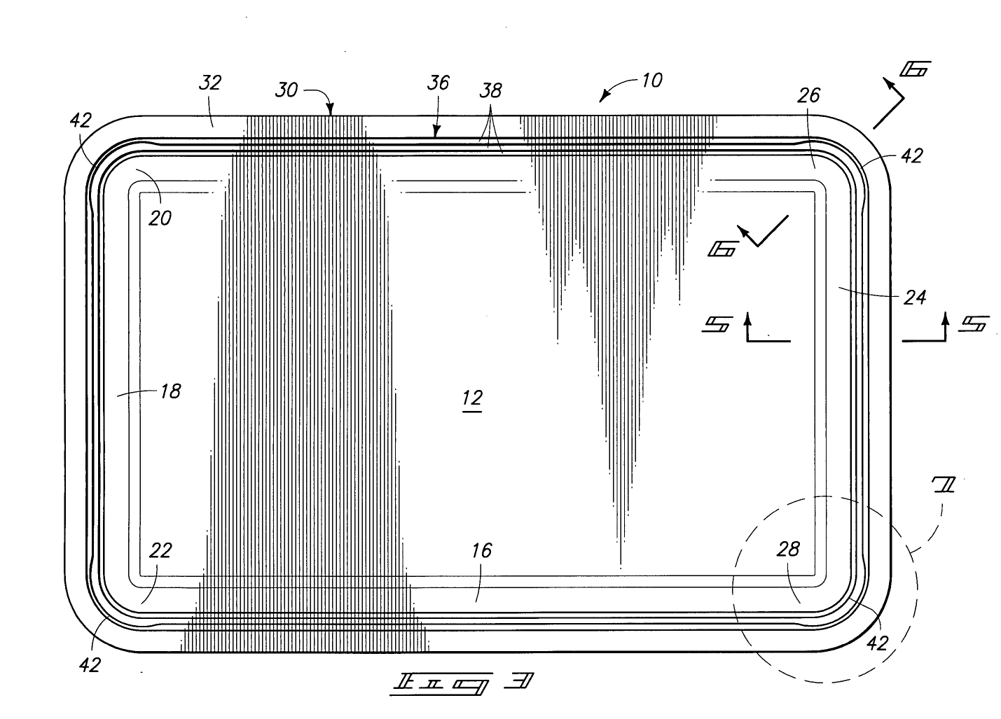

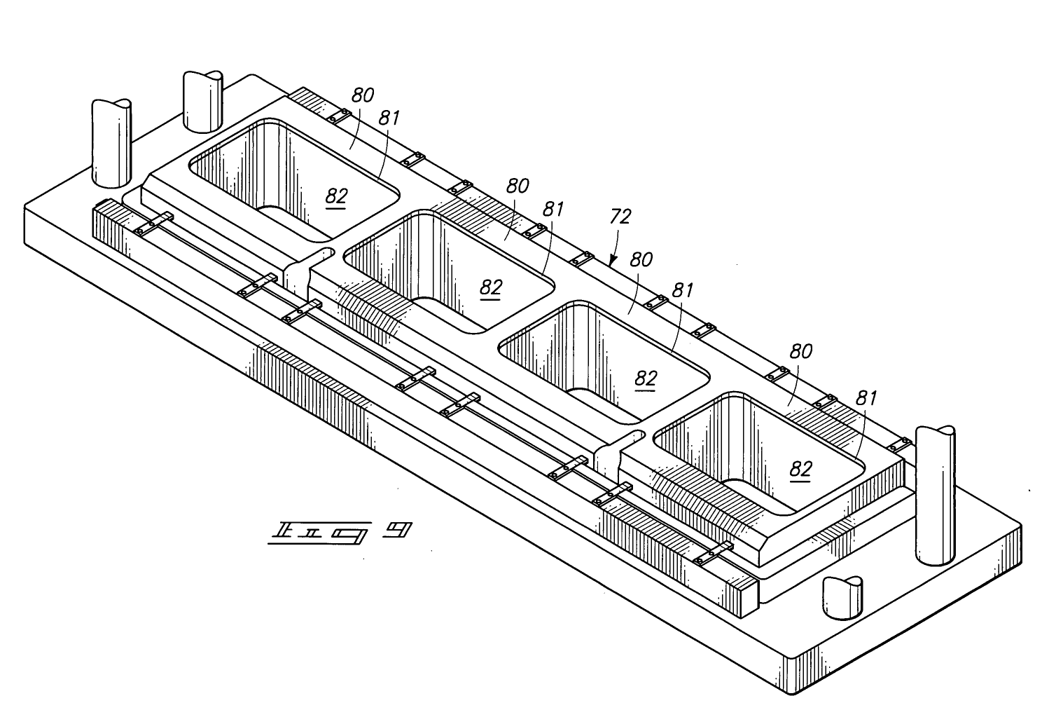

Preferably the alignment corner surfaces 42 are convex curved as seen in the top views FIGS. 3 and 7. Preferably the alignment corner surfaces are curved in an arc of more than 90 degrees, but less than 180 degrees, with a radius of curvature 44 about a center of curvature 46 (FIG. 7). Preferably each alignment corner surface 42 is conical in shape having a wide curved arc in the horizontal direction and a steep inclined shallow conical wall element in the vertical direction.

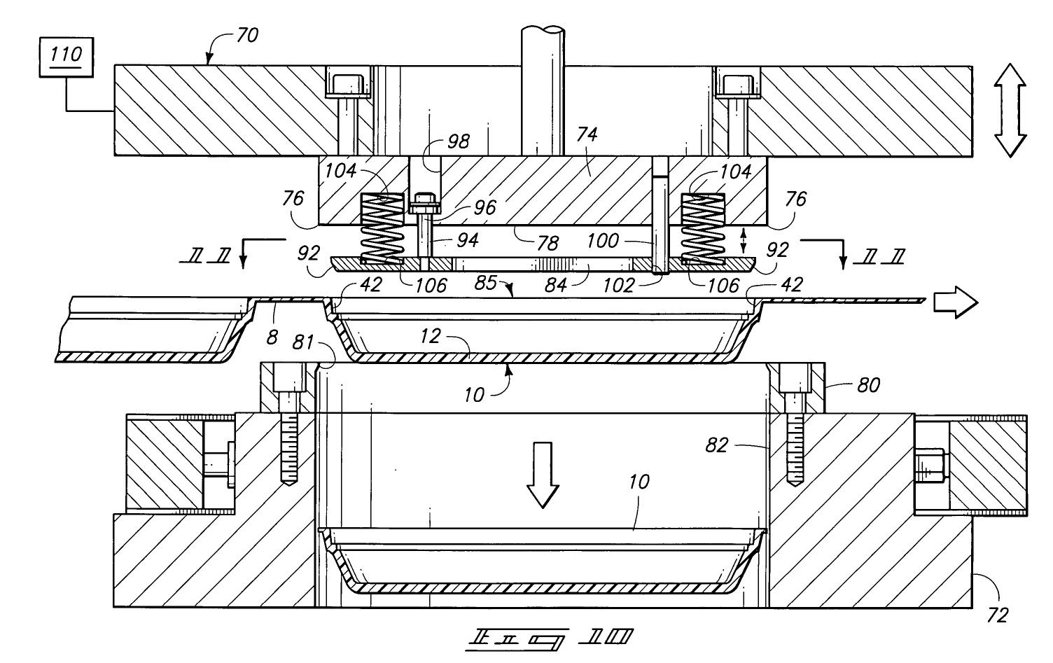

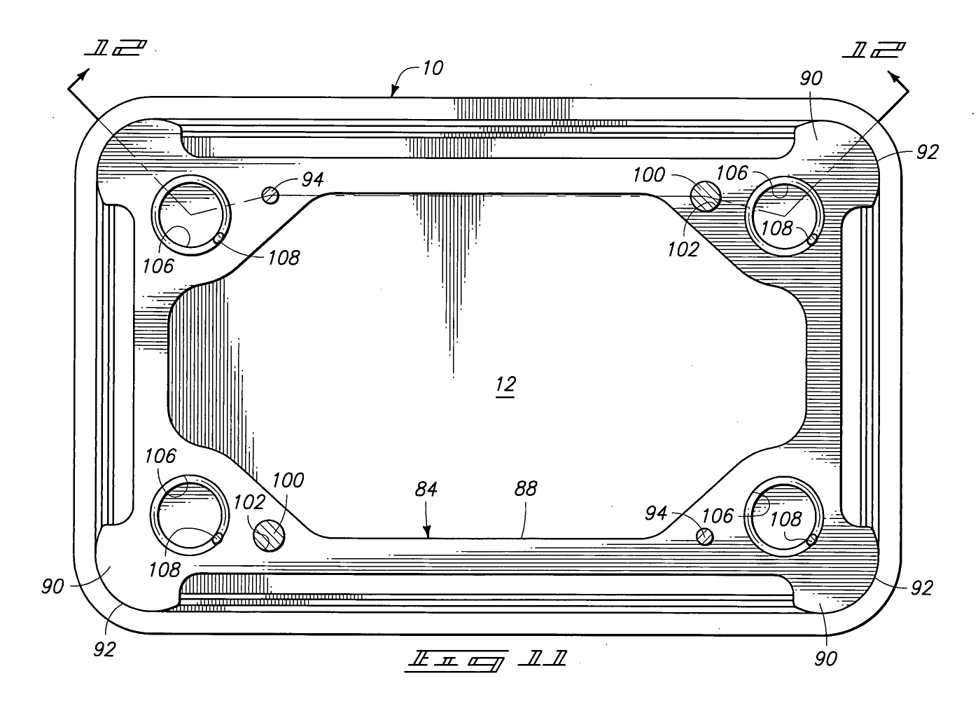

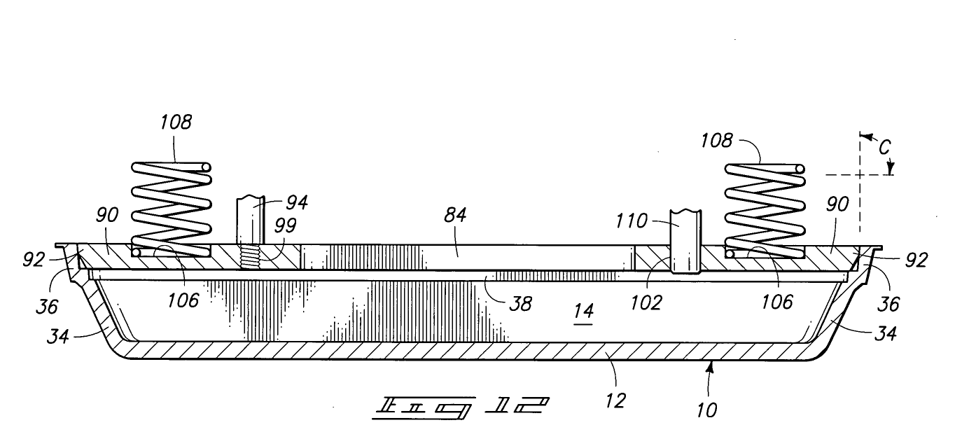

A trim press is located at the trimming station 54 for trimming and separating one or more meat trays 10 at a time from the web 8. The reader is directed to previously mentioned U.S. Pat. No. 6,067,886 for many of the details of such a trim press. For purpose of brevity the above-mentioned U.S. Pat. No. 6,067,886 is incorporated by reference should the reader desire such detail. For the purpose of this application, the important features are a unique punch platen 70 and a complementary die platen 72, which are described in more detail with reference to FIGS. 8-12.

The punch platen 70 has a plurality (row) of rectangular male punch elements of plates 74 mounted thereon. Each punch plate 74 has a generally rectangular peripheral cutting edge 76 surrounding a front face surface 78.

The die platen 72 has a plurality (row) of female die elements 80 that are complementary to the punch plates 74. Each of the die elements 80 has an internal cutting edge 81 surrounding a generally rectangular pass-through opening 82.

Importantly, each of the male punch plates 74 has a meat tray alignment fixture 84 projecting forward of the front face surface 78 that moves in conjunction with a respective plate 74 for initially entering the meat tray 10 and aligning the meat tray 10 longitudinally, laterally and angularly with respect to the respective punch plate 74 and die element 82. As the fixture 84 enters the rectangular meat tray 10 it engages the alignment corner surfaces 42 to stretch at least the upper section 36 of the meat tray in the diagonal directions as well as in the longitudinal, lateral and angular directions to enable the lip 30 to be trimmed precisely as the cutting edges 76 and 81 sever the meat tray from the web 8.

Preferably, each alignment fixture 84 has a thin, generally rectangular-shaped plate or spider body 86 with an enlarged central void or opening 88. Enlarged corner elements 90 extend outward at the corners. Each element 90 has a peripheral exterior side surface 92 complementary to the internal corner alignment surface 42 of the meat tray 10 for engaging the internal corner alignment surface 42 as the fixture 84 enters the top opening of the meat tray 10. Preferably each of the exterior side surfaces 92 is steeply inclined at an acute angle “C” of between 75 degrees and 86 degrees relative to the bottom wall of the meat tray (FIG. 12). More preferably the acute angle “C” is between 80 degrees and 86 degrees. Also preferably each of the exterior side surfaces 92 has an arc in the horizontal direction of greater than 90 degrees.

The alignment fixture 84 is mounted to the punch plate 74 by at least two diagonally spaced support bolts 94. The bolts 94 have bolt shafts 96 slidably mounted in a countersunk bore 98 formed in the punch plate 74 to enable the thin plate 86 to move from an extended position to a retracted position relative to the front face surface 78. Each bolt 94 has an outer end 99 that is threaded in a complementary threaded aperture in the thin plate 86.

The alignment fixture 84 further includes guide rods 100 that are mounted in the face surface 78 and extend outward projecting through guide apertures 102 in the thin plate 86 to maintain the fixture 84 aligned with the punch plates 74 as the thin plate 86 moves between the extended position and the retracted position. Corner coil springs 108 are mounted between the alignment fixture 84 and the punch plate 74 to bias the alignment fixture 84 to the extended position. The corner coil springs 108 are seated in shallow spring cavities 104 and 106 formed respectively in the punch plate 74 and the thin plate 86.

The punch platen 70 is reciprocated to and from the die platen 72 by a punch drive 110. See the above-identified U.S. Pat. No. 6,067,886 for specific structural details. As the punch platen 70 is moved a first distance toward the die platen 72, the alignment fixture 84 is moved into the top opening of the meat tray (FIG. 12) with the exterior side surfaces 92 engaging the interior corner alignment surfaces 42 of the meat tray to accurately align the meat tray 10 relative to the cutting edges 76 and 81. As previously mentioned, the alignment fixture 84 aligns the meat tray 10 diagonally between the corners, as well as longitudinally, laterally and angularly relative to the cutting edges 76 and 81.

Further movement of the punch platen 70 moves the aligned meat tray 10 into the die opening 82 with the lip 30 engaging the die element 80, causing the alignment fixture 84 to move from the extended position to the retracted position while maintaining alignment, and brings the cutting edges 76 and 81 into cutting relationship with the web 8 to trim the lip 30 and sever the meat tray from the web 8. Once the trays 10 are severed from the web 8, the coil springs 108 bias the alignment fixture 84 outward from the plate 74, pushing the severed meat tray 10 into the pass-through opening 82 and onto an exit conveyer (not shown).

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

The invention claimed is:

1. A thermoformed article trim apparatus for severing thermoformed articles with an accurately trimmed lip edge from a thermoformed web in which each article has diagonally opposing corner surfaces, comprising:
an article die;
an article punch opposing the article die;
an alignment fixture carried by the punch and having complementary exterior alignment corner surfaces configured to engage inclined interior corner surfaces of the article to maintain the article in alignment in longitudinal, lateral and angular directions; and
a drive mechanism connected to at least one of the die and the punch and configured to move at least one of the punch and the die relative to each other a first distance to move the alignment fixture into the article with the exterior alignment corner surfaces of the article to accurately align the article in the longitudinal, lateral and angular directions and further configured to move a second distance to accurately trim the article from the web to generate an accurately formed lip around a periphery of the article while the alignment fixture corner surfaces are engaging the article corner surfaces.

2. The thermoformed article trim press of claim 1, wherein the punch comprises a face plate, and wherein the alignment fixture is mounted on the face plate for movement between an extended position and a retracted position while the punch and the die are moved relative to one another.

3. The thermoformed article trim press of claim 1, wherein the alignment fixture has a generally rectangular shape with four corner projections, each extending outwardly with the inclined fixture corner surfaces being formed thereon for engaging the inclined corner surfaces of the article.

4. The thermoformed article trim press of claim 3, wherein the corner projections have curved corner surfaces with an arc of greater than 90 degrees about a center of curvature.

5. The thermoformed article trim press of claim 1, wherein the fixture corner surfaces are curved and extend downward and inward at an angle of between 75 and 86 degrees relative to a bottom wall of the article.

6. The thermoformed article trim press of claim 1, wherein the article comprises a rectangular meat tray.

7. A trim apparatus for severing uncut thermoformed rectangular meat trays with precisely trimmed lips from a thermal plastic expanded foam web in which each meat tray has diagonally opposing steeply inclined interior corner surfaces, comprising:
a. a rectangular meat tray die;
b. a rectangular meat tray punch opposing the rectangular meat tray die;
c. an alignment fixture mounted on the punch having complementary exterior alignment corner surfaces thereon for engaging the steeply inclined interior corner surfaces of the meat tray to maintain the meat tray in alignment in the longitudinal, lateral and angular directions;
d. placement means for placing an untrimmed meat tray between the punch and die;
e. drive means operatively connected to the die and punch for (1) moving the punch and die relative to each other a first distance to move the alignment fixture into the meat tray with the exterior alignment corner surfaces engaging the steeply inclined corner surfaces of the meat tray to accurately align the meat tray in the longitudinal, lateral and angular directions, and (2) moving a second distance to accurately trim the meat tray from the web with a precisely formed lip about its periphery while the fixture corner surfaces are engaging the tray corner surfaces.

8. The trim apparatus as defined in claim 7, wherein the punch has a face plate and wherein the alignment fixture is mounted on the face plate for movement between an extended position to a retracted position while the punch and die are moved relative to each other.

9. The trim apparatus as defined in claim 7, wherein the alignment fixture has a generally rectangular shape with corner projections extending outwardly with the inclined fixture corner surfaces being formed thereon for engaging the steep inclined corner surfaces of the meat tray.

10. The trim apparatus as defined in claim 9, wherein the corner projections have curved corner surfaces with an arc of greater than 90 degrees about a center of curvature.

11. The trim apparatus as defined in claim 7, wherein the fixture corner surfaces are curved and extend downward and inward at an angle of between 75 and 86 degrees relative to the bottom wall of the meat tray.

12. A process for severing uncut thermal formed rectangular meat trays with precisely trimmed lips from a thermal plastic expanded foam web in which each meat tray has diagonally opposing steeply inclined interior corner surfaces, comprising:
a. moving the web to place at least one of the rectangular meat trays between a rectangular meat tray punch and a rectangular-meat tray die, in which the rectangular punch has an alignment fixture thereon with complementary steeply inclined exterior alignment surfaces for engaging the steeply inclined interior corner surfaces of the meat trays;
b. moving the punch and die relative to each other a first distance to insert the alignment fixture within the meat tray with the alignment surfaces engaging the diametrically opposed interior corner surfaces of the meat tray to accurately align the meat tray longitudinally, laterally and angularly with respect to the punch and die; and
c. while maintaining the alignment surfaces in engagement with the corner surfaces, moving the punch and die relative to each other a second distance to sever the meat tray from the web with a precisely formed lip about its periphery.

13. The process of claim 12, while moving the punch and die relative to each other the second distance, moving the accurately aligned meat tray into a die opening in the die.

14. The process of claim 12, while moving the punch and die relative to each other from the first distance to the second distance, moving the alignment fixture relative to the punch from an extended position to a retracted position.

15. The process of claim 12, further comprising resiliently mounting the alignment fixture onto the punch with at least one spring.

16. The process of claim 12, after moving the punch and die the second distance to sever the meat tray from the web, pushing the severed meat tray into a pass-through opening in the die and onto an exit conveyor.
